(19) United States
(12) Patent Application Publication
(10) Pub. No.: US 2018/0148604 A1
(43) Pub. Date: May 31, 2018

(54) CLEAR BINDER AND APPLICATIONS OF SAME

(71) Applicant: TOTAL MARKETING SERVICES, Puteaux (FR)

(72) Inventors: Danièle BARJON, Les Roches de Condrieu (FR); Olivier GAMET, Bailly Romainvilliers (FR); Mouhamad MOUAZEN, Lyon (FR)

(73) Assignee: TOTAL MARKETING SERVICES, Puteaux (FR)

(21) Appl. No.: 15/566,256

(22) PCT Filed: Apr. 13, 2016
(86) PCT No.: PCT/EP2016/058108

§ 371 Date: Oct. 13, 2017

(30) Foreign Application Priority Data
Apr. 13, 2015 (FR) 1553197

(51) Int. Cl. C09D 191/00; C04B 26/10; C04B 24/00; C08L 91/00; C08J 3/20; E01C 7/30

(52) U.S. Cl. CPC C09D 191/00; C04B 26/10; C04B 24/00; C04B 2103/30; C08J 3/203; E01C 7/30; C08L 91/00

(57) ABSTRACT

A clear binder is used in colored compositions in certain road and/or industrial applications.

### TECHNICAL FIELD

The present invention relates to a clear binder and to its uses in colored compositions in certain road and/or industrial applications.

### TECHNOLOGICAL BACKGROUND

Conventional asphalt binders, due to the presence of asphaltenes, are black in color and are thus difficult to color. Colored surfacings are increasingly used as they make it possible, inter alia, to improve the safety of road users by clearly identifying specific routes, such as pedestrian pathways, cycle tracks or bus lanes. They also make it possible to mark certain danger zones, such as entries to towns or dangerous bends. Colored surfacings promote visibility under low light conditions, for example at night or in specific sites, such as tunnels. Finally, they make it possible very simply to improve the esthetic appearance of urban highways and can be used for public places, courtyards of apartment buildings, school playgrounds, sidewalks, pedestrianized streets, paths of gardens and parks, or parking and rest areas.

Consequently, for all the abovementioned applications, it is preferable to use clear synthetic binders which do not contain asphaltenes and which can be colored.

The clear binders of the prior art generally consist of a plasticizing agent, for example an oil of petroleum origin, a structuring agent, for example a hydrocarbon resin, and a polymer. The composition of the clear binders determines certain essential properties of these binders, in particular the plasticity index, the viscosity of the binder or the color, which has to be as light as possible.

The patent application WO 01/53409 describes a clear binder comprising hydrogenated white oils comprising at least 60% of paraffinic carbons (according to the ASTM D2140 method) and a hydrocarbon resin, if appropriate as a mixture with copolymers of the ethylene/vinyl acetate (EVA) or low density polyethylene type, for example of the EPDM (ethylene/propylene/diene monomer) type. These compositions are recommended for the preparation of colored leaktightness membranes or coverings.

The patent application EP 1 783 174 describes a clear binder comprising an oil with a content of naphthenics of between 35% and 80% and a hydrocarbon resin.

The patent application EP 1 473 327 describes a clear binder comprising a synthetic oil, a resin and a polymer of SBS or SIS type and their uses in the preparation of leaktightness membranes or coverings.

For use in colored surfacing applications, a clear binder should ideally satisfy the following physical/mechanical properties:

a satisfactory plasticity index, that is to say a low (Fraass) breaking point and a high softening point (ring-and-ball temperature),

a low viscosity,

a clear color which changes little over time,

good resistance to rutting,

good resistance to thermal cracking,

a low sensitivity to water.

The applicant company has established, surprisingly, that the judicious choice of a synthetic oil having a high content of paraffinic compounds and of a block copolymer, for example of the SBS type, makes it possible to obtain a clear binder with improved physical/mechanical properties.

### SUMMARY

A subject matter of the present invention is thus a clear binder comprising:

(i) a plasticizing agent consisting of an oil containing a total content of paraffinic compounds, measured according to the ASTM D2140 method, of at least 50%, preferably of at least 60%, by weight, more preferably of between 50% and 90%, preferably between 60% and 80%, and
(ii) a block copolymer based on conjugated diene units and on monovinylaromatic hydrocarbon units, for example based on butadiene units and on styrene units.

In a preferred embodiment, the oil is a synthetic oil resulting from the cuts of a deasphalting unit (or “DAO oil”).

In a specific embodiment, the oil contains a total content of paraffinic compounds of greater than or equal to 50%, preferably of greater than or equal to 60%, by weight, and a total content of naphthenic compounds of less than or equal to 25% by weight, measured according to the ASTM D2140 method.

For example, the oil contains a total content of paraffinic compounds of between 50% and 90% and a total content of naphthenic compounds of between 5% and 25% by weight, measured according to the ASTM D2140 method.

In a specific embodiment, the oil contains a total content of paraffinic compounds of greater than or equal to 50%, preferably of greater than or equal to 60%, by weight, a total content of naphthenic compounds of less than or equal to 25% by weight and a total content of aromatic compounds of less than or equal to 25% by weight, measured according to the ASTM D2140 method.

For example, the oil contains a total content of paraffinic compounds of between 50% and 90%, preferably between 60% and 80%, by weight, a total content of naphthenic compounds of between 5% and 25% by weight and a total content of aromatic compounds of between 5% and 25% by weight, measured according to the ASTM D2140 method.

In a specific embodiment, optionally combined with the preceding embodiments, the oil has an aniline point, measured according to the ISO 2977: 1997 standard, of greater than or equal to 80° C., preferably of greater than or equal to 90° C., for example of greater than 100° C.

The clear binder according to the invention preferably comprises (i) from 40% to 80% by weight of plasticizing agent, (ii) from 20% to 50% by weight of resin, (iii) from 1% to 7% by weight of copolymer and (iv) optionally from 0.05% to 0.5% by weight of adhesion agent, for example of amine, with respect to the weight of clear binder.

The clear binder according to the invention preferably comprises (i) from 40% to 80% by weight of plasticizing agent, (ii) from 20% to 50% by weight of resin, (iii) from 1% to 7% by weight of copolymer and (iv) from 0.05% to 0.5% by weight of adhesion agent, for example of amine, with respect to the weight of clear binder.

Advantageously, the clear binder according to the invention comprises (i) from 45% to 70% by weight of plasticizing agent, (ii) from 25% to 40% by weight of resin, (iii) from 2% to 5% by weight of copolymer and (iv) optionally from 0.1% to 0.3% by weight of adhesion agent, with respect to the total weight of clear binder.

According to another advantageous embodiment, the clear binder according to the invention comprises (i) from 45% to 70% by weight of plasticizing agent, (ii) from 25% to 50% by weight of resin, (iii) from 1% to 7% by weight of copolymer and (iv) optionally from 0.1% to 0.3% by weight of adhesion agent, with respect to the total weight of clear binder.

According to a preferred embodiment, the clear binder according to the invention is essentially composed of (i) from 40% to 80% by weight of plasticizing agent, (ii) from 20% to 50% by weight of resin and (iii) from 1% to 7% by weight of copolymer.

According to another preferred embodiment, the clear binder according to the invention is essentially composed of (i) from 40% to 80% by weight of plasticizing agent, (ii) from 20% to 50% by weight of resin, (iii) from 1% to 7% by weight of copolymer and (iv) from 0.05% to 0.5% by weight of adhesion agent.

Advantageously, the clear binder is essentially composed of (i) from 45% to 70% by weight of plasticizing agent, (ii) from 25% to 40% by weight of resin, (iii) from 2% to 5% by weight of copolymer and (iv) from 0.1% to 0.3% by weight of adhesion agent, with respect to the total weight of clear binder.

According to another advantageous embodiment, the clear binder is essentially composed of (i) from 45% to 70% by weight of plasticizing agent, (ii) from 25% to 50% by weight of resin, (iii) from 1% to 7% by weight of copolymer and (iv) from 0.1% to 0.3% by weight of adhesion agent, with respect to the total weight of clear binder.

In another specific embodiment, optionally combined with the preceding embodiments, the block copolymer is a copolymer based on styrene and butadiene units which comprises a content by weight of 1,2-vinyl units ranging from 5% to 70%, preferably from 5% to 50%.

In another specific embodiment, optionally combined with the preceding embodiments, the block copolymer is a copolymer based on styrene and butadiene units which comprises a content by weight of 1,2-vinyl units ranging from 10% to 70%, preferably from 10% to 50%. In another specific embodiment, optionally combined with the preceding embodiments, the block copolymer is advantageously a block copolymer based on styrene and butadiene units which comprises a content by weight of butadiene ranging from 50% to 95% and a content by weight of 1,2-vinyl groups ranging from 10% to 70%.

For example, said block copolymer based on styrene and butadiene units has an average molecular weight of between 10 000 and 500 000, preferably between 50 000 and 200 000 and more preferably between 50 000 and 150 000 daltons. Preferably, use will be made of a styrene/butadiene block or styrene/butadiene/styrene block copolymer.

The clear binders according to the invention are advantageously characterized in that they exhibit a color index of less than or equal to 4, preferably of less than or equal to 3, as determined according to the ASTM DH4 scale. In addition, they can advantageously exhibit a ring-and-ball softening temperature, determined according to the NF EN1427 standard, of between 55° C. and 90° C. and a Fraass breaking point, determined according to the NF EN12593 standard, of less than or equal to −5° C., preferably of less than or equal to −10° C. and more preferably of less than or equal to −12° C. They can also exhibit a dynamic viscosity at 135° C. of less than or equal to 0.5 Pa·s, preferably of less than or equal to 0.35 Pa·s, measured according to the NF EN13702 standard.

The invention also relates to a process for the preparation of a clear binder according to the invention as described above, said process comprising the following stages:
the mixing of the plasticizing agent, for example a DAO oil, and heating to a temperature of between 140 and 200° C., for example from 10 minutes to 30 minutes,
the addition of the structuring agent, for example a hydrocarbon resin, mixing and heating to a temperature of between 140 and 200° C., for example from 30 minutes to 2 hours,
the addition of the copolymer, mixing and heating to a temperature of between 140 and 200° C., for example from 90 minutes to 2 hours 30 minutes,
the addition of the optional adhesion agent, mixing and heating between 140 and 200° C. between 5 minutes and 20 minutes.

The order of the stages of the above process can be modified, if appropriate.

The invention additionally relates to a colored or colorable mix comprising a clear binder according to the invention, an aggregate and/or other mineral fillers, and optionally one or more pigments.

The invention additionally relates to an emulsion based on a clear synthetic binder according to the invention, in particular in the manufacture of surface coatings or cold-poured mixes.

The invention is also targeted at the applications of the clear binder according to the invention and in particular at the preparation of colorable or colored mixes intended for road or urban surfacings. The clear binder according to the invention is, for example, used as a mixture with aggregates or other mineral fillers, dopes and/or pigments.

The invention also relates the use of the clear binder as lubricant for cableway cables or more generally for cables used in the transportation of heavy loads and exposed to temperatures of less than −10° C. and/or to high ranges in temperature.

Throughout the patent application, when the expression “between x and y” is used, it is understood that the limits are also included in the interval thus defined.

### DETAILED DESCRIPTION OF THE INVENTION

The invention relates to a clear binder comprising:

(i) a plasticizing agent consisting of an oil containing a total content of paraffinic compounds, measured according to the ASTM D2140 method, of at least 50%, preferably of at least 60%, by weight, more preferably of between 50% and 90%, preferably between 60% and 80%, and
(ii) a block copolymer based on conjugated diene units and on monovinylaromatic hydrocarbon units, for example based on butadiene units and on styrene units.

The clear binder is a composition which can be used as replacement for asphalt-based binders in the preparation, for example, of a colored asphalt mix. A clear binder is devoid of asphaltenes and can thus retain the natural shade of the aggregate with which it is mixed or be easily colored using pigments.

The essential constituents of a clear binder are:

i) a plasticizing agent, for example a natural or synthetic oil, devoid of asphaltenes,
ii) a structuring agent, for example a hydrocarbon resin,
iii) a block copolymer,
iv) if appropriate, doping agents, or dopes, or adhesion agents.

### The Plasticizing Agent

The term “plasticizing agent” is understood to mean, within the meaning of the invention, a chemical constituent which makes it possible to fluidize and to reduce the viscosity and the modulus of the binder obtained.

In a preferred embodiment of the invention, the plasticizing agent is chosen from the synthetic oils resulting from the cuts from deasphalting from distillation under reduced pressure (vacuum residue, VR) of crude oil (hereinafter known as “DAO oil”).

In particular, in a preferred embodiment, the plasticizing agent according to the invention consists solely of a DAO oil.

The contents of paraffinic, naphthenic and aromatic compounds mentioned in the present patent application are determined according to the ASTM D2140 standard, as % by weight with respect to the weight of the oil.

In a specific embodiment, the plasticizing agent is an oil, for example a DAO oil, containing a total content of paraffinic compounds of at least 50% by weight, preferably of at least 60% by weight, for example of between 50% and 90%, preferably between 60% and 90%, more preferably between 50% and 80% and in particular of between 55% and 70% or in particular of between 60% and 75%.

In a more specific embodiment, the plasticizing agent is an oil, for example a DAO oil, additionally containing a total content of naphthenic compounds which does not exceed 25%, for example of between 5% and 25% and in particular of between 10% and 25%.

In a more specific embodiment, the plasticizing agent is an oil, for example a DAO oil, additionally containing a total content of aromatics which does not exceed 25%, for example of between 5% and 25% and in particular of between 8% and 18%.

In a particularly preferred embodiment, the plasticizing agent is an oil, for example a DAO oil, comprising the following respective contents:

(i) a total content of paraffinic compounds of between 50% and 90%:
(ii) a total content of naphthenic compounds of between 5% and 25%, for example between 15% and 25%; and
(iii) a total content of aromatic compounds of between 5% and 25%, for example between 10% and 15%.

In a more particularly preferred embodiment, the plasticizing agent is an oil, for example a DAO oil, comprising the respective contents:

(i) a total content of paraffinic compounds of between 60% and 75%:
(ii) a total content of naphthenic compounds of between 5% and 25%, for example between 15% and 25%; and
(iii) a total content of aromatic compounds of between 5% and 25%, for example between 10% and 15%.

Oils corresponding to the above characteristics and which can be used for the preparation of the clear binder according to the invention are obtained by processes for the deasphalting of the vacuum residues (VRs) resulting from the refining of oil, for example by a deasphalting using a C₃ to C₆ solvent, preferably with propane. These deasphalting processes are well known to a person skilled in the art and are described, for example, in Lee et al., 2014, Fuel Processing Technology, 119, 204-210. The residues resulting from the vacuum distillation (VRs) are separated according to their molecular weight in the presence of C₃ to C₆ solvent (for example propane). The oil referred to as DAO oil (“deasphalted oil”) thus obtained is rich in paraffin, exhibits a very low content of asphaltenes, has an evaporation temperature of between 440° C. and 750° C. and has a much greater API gravity than that of the vacuum residues.

The respective contents of paraffinic, naphthenic and aromatic compounds depend to a certain extent on the nature of the crude oil from which the DAO oil originates and on the refining process used. A person skilled in the art knows how to determine the respective contents of paraffinic, naphthenic and aromatic compounds of a DAO oil, for example using the SARA fractionation method also described in Lee et al., 2014, Fuel Processing Technology, 119, 204-210, and thus to select the DAO oil appropriate for the preparation of the clear binder according to the invention.

In a specific embodiment, the amount of plasticizing agent employed in the process for the preparation of the clear binder is between 40% and 80%, preferably between 45% and 70%, by weight, with respect to the total weight of clear binder.

### The Structuring Agent

The term “structuring agent” is understood to mean any chemical constituent which confers mechanical properties and a satisfactory cohesiveness on said binder.

The structuring agent used in the context of the invention is a resin preferably chosen from resins of petroleum hydrocarbon origin, for example resulting from the copolymerization of aromatic, aliphatic or cyclopentadienic petroleum cuts, taken alone or as a mixture, preferably resulting from aromatic petroleum cuts. For example, it can be a polycycloaliphatic thermoplastic resin, for example of the hydrogenated cyclopentadiene homopolymers type, having a low molecular weight.

More particularly, the hydrocarbon resin of the cyclopentanes type has a softening point (or ring-and-ball temperature, BRT, according to the NF T 66-008 standard) of greater than 125° C. and a Gardner color index (according to the NF T 20-030 standard) equal to at most 1.

Other examples of resins which can be used as structuring agent include, without being limiting, resins of plant origin obtained from vegetables and/or plants. They can be “harvested” resins, that is to say resins harvested from the living plant. They can be used as is (reference is then made to natural resins) or be converted chemically (reference is then made to modified natural resins).

The harvested resins include acaroid resins, dammar, natural rosins, modified rosins, rosin esters and metal resinates. These can be taken alone or as a mixture.

Mention may be made, among natural rosins, of gum and wood rosins, in particular pine rosin and/or tall oil rosin. These natural rosins can be taken alone or as a mixture.

Mention may be made, among modified rosins, of hydrogenated rosins, disproportionated rosins, polymerized rosins and/or maleinized rosins. These modified natural rosins can be taken alone or as a mixture and can be subjected to one or more disproportionation, polymerization and/or maleinization treatments.

Mention may be made, among rosin esters, of methyl esters of natural rosins, methyl esters of hydrogenated rosins, esters of glycerol and of natural rosins, esters of glycerol and of hydrogenated rosins, esters of glycerol and of disproportionated rosins, esters of glycerol and of polymerized rosins, esters of glycerol and of maleinized rosins, esters of pentaerythritol and of natural rosins and esters of pentaerythritol and of hydrogenated rosins. These rosin esters can be taken alone or as a mixture and can originate from rosins which have been subjected to one or more disproportionation, polymerization and/or maleinization treatments.

The esters of pentaerythritol and of natural rosins and the esters of pentaerythritol and of hydrogenated rosins are the preferred rosin esters.

Mention may be made, among metal resinates, of metal carboxylates, for example of Ca, Zn, Mg, Ba, Pb or Co, obtained from natural rosins or from modified rosins. Preference is given to calcium resinates, zinc resinates or mixed calcium/zinc resinates, taken alone or as a mixture.

The ratio by weight of the structuring agent to the plasticizing agent employed in the preparation of the clear binder according to the invention is generally between 0.3 and 1.5, for example between 0.5 and 1.

In a specific embodiment, the amount of structuring agent employed in the process for the preparation of the clear binder is between 25% and 50% by weight, with respect to the total weight of clear binder.

### The Polymer

The polymer employed in the process for the preparation of the clear binder according to the invention is a block copolymer based on conjugated diene units and on monovinylaromatic hydrocarbon units. The conjugated diene is preferably chosen from those comprising from 4 to 8 carbon atoms per monomer, for example butadiene, 2-methyl-1,3-butadiene (isoprene), 2,3-dimethyl-1,3-butadiene, 1,3-pentadiene and 1,2-hexadiene, chloroprene, carboxylated butadiene or carboxylated isoprene, in particular butadiene and isoprene, and their mixtures.

The monovinylaromatic hydrocarbon is preferably chosen from styrene, o-methylstyrene, p-methylstyrene, p-(tert-butyl)styrene, 2,3-dimethylstyrene, Pa-methylstyrene, le vinylnaphthalene, vinyltoluene, vinylxylene and analogs or their mixtures, in particular styrene.

More particularly, the polymer consists of one or more block copolymers chosen from sequential copolymers of styrene and butadiene, of styrene and isoprene, of styrene and chloroprene, of styrene and carboxylated butadiene or of styrene and carboxylated isoprene. A preferred block copolymer is a copolymer based on butadiene units and on styrene units, such as the styrene/butadiene SB block copolymer or the styrene/butadiene/styrene SBS block copolymer.

The block copolymer of styrene and of conjugated diene, in particular the block copolymer of styrene and of butadiene, advantageously has a content by weight of styrene ranging from 5% to 50% and preferably from 20% to 50%.

The block copolymer of styrene and of conjugated diene, in particular the block copolymer of styrene and of butadiene, advantageously has a content by weight of butadiene (1,2- and 1,4-) ranging from 50% to 95%. The block copolymer of styrene and of conjugated diene, in particular the copolymer of styrene and of butadiene, advantageously has a content by weight of 1,2-vinyl groups ranging from 10% to 70%, preferably from 10% to 50%, more preferably from 10% to 40% and more preferably still from 20% to 40%. The 1,2-vinyl groups are the units which result from the polymerization of the butadiene units via the 1,2-addition.

The average molecular weight of the block copolymer of styrene and of conjugated diene and in particular that of the copolymer of styrene and of butadiene can, for example, be between 10 000 and 500 000, preferably between 50 000 and 200 000 and more preferably from 50 000 to 150 000 daltons.

In a specific embodiment, the clear binder does not comprise polymer of the ethylene/vinyl acetate (EVA) type or of the low-density polyethylene type, such as EPDM (ethylene/propylene/diene monomer) or EPM (ethylene/propylene monomer).

In a specific embodiment, the total amount of block polymer employed in the process of the invention is between 0.5% and 20% by weight, preferably between 1% and 10%, preferably between 1% and 7%, for example between 2% and 5%.

### The Adhesion Agents

Adhesion agents can also be used in order to improve the reciprocal affinity between the binder and the aggregates and to ensure the durability thereof. They are, for example, nitrogenous surface-active compounds derived from fatty acids (amines, polyamines, alkylpolymanne, and the like).

When they are added to the clear binder, the adhesion agents generally represent between 0.05% and 0.5% by weight, with respect to the weight of clear binder. For example, in a specific embodiment, between 0.05% and 0.5% of amine, preferably between 0.1% and 0.3% of amine, will be added.

### The Coloring Agents

The clear synthetic binder can also comprise one or more coloring agents, such as inorganic pigments or organic dyes. The pigments are selected according to the shade or the color desired for the surfacing. Use will be made, for example, of metal oxides, such as iron oxides, chromium oxides, cobalt oxides or titanium oxides, in order to obtain red, yellow, gray, blue-green or white colors. The pigments can be added without distinction in the clear binder or in the mix (as a mixture with the aggregates, for example) or in an emulsion of the clear binder.

### Process for the Preparation of the Clear Binder

The present invention also relates to the process for the preparation of the clear binders according to the invention. This process comprises the following stages:

(i) mixing of the plasticizing agent, for example DAO oil, and heating to a temperature of between 140-200° C., for example from 10 minutes to 30 minutes,
(ii) addition of the structuring agent, for example hydrocarbon resin, mixing and heating to a temperature of between 140-200° C., for example from 30 minutes to 2 hours,
(iii) addition of the polymer or polymers, for example SBS, mixing and heating to a temperature of between 140-200° C., for example from 90 minutes to 3 hours, preferably from 90 minutes to 2 hours 30,
(iv) optional addition of an adhesion agent, mixing and heating to a temperature of between 140-200° C., for example from 5 minutes to 20 minutes.
The order of stages (i) to (iv) can be modified.

In a specific embodiment, a clear binder composition according to the invention comprises, with respect to the total weight of clear binder:

(i) from 40% to 80% by weight, preferably from 45% to 70% by weight, of plasticizing agent, preferably between 55% and 70% by weight of plasticizing agent, for example a DAO oil,
(ii) from 20% to 45% by weight, preferably from 25% to 40% by weight, of structuring agent, for example a hydrocarbon resin,
(iii) from 1% to 7% by weight of polymers, preferably between 4% and 6% of polymers, for example a block copolymer of SBS type,
(iv) optionally from 0.05% to 0.5% by weight of dope, preferably between 0.1% and 0.3% by weight of dope, for example amines.

Preferably, the clear binder according to the invention has a penetrability a 25° C., measured according to the NF EN 1426 standard, of between 10 and 220 1/10 mm, preferably between 30 and 100 1/10 mm, more preferably between 40 and 80 1/10 mm, preferably again between 10 and 50 1/10 mm, more preferably between 10 and 40 1/10 mm. A person skilled in the art can adjust the penetrability of the clear binder, in particular by judiciously choosing the [structuring agent/plasticizing agent] ratio by weight in the composition of the clear binder. This is because it is known that an increase in this ratio makes it possible to reduce the penetrability at 25° C.

Preferably, the clear binder according to the invention exhibits a ring-and-ball softening temperature, determined according to the NF EN1427 standard, of between 50° C. and 90° C. and a Fraass breaking point, determined according to the NF EN12593 standard, of less than or equal to −5° C., preferably of less than or equal to −10° C. and more preferably of less than or equal to −12° C.

Preferably, the clear binder according to the invention exhibits a color index of less than or equal to 4, preferably of less than or equal to 3, as determined according to the ASTM DH4 scale.

Preferably, the clear binder according to the invention exhibits a dynamic viscosity at 135° C. of less than or equal to 0.5 Pa·s, preferably of less than or equal to 0.35 Pa·s, said viscosity being measured according to the NF EN 13702 standard.

Preferably, the clear binder according to the invention exhibits a resistance to rutting at 10 000 cycles of less than 15%. The test of resistance to rutting is carried out according to the NF EN 12697-22 A1 and IN1 standard in order to determine the behavior in deformation of asphalt materials subjected to running loads.

### Applications of the Clear Binder

The clear binder according to the invention can be used and applied without distinction via “hot” or “warm” techniques or “cold” techniques well known to a person skilled in the art.

The term “hot techniques” is understood to mean techniques in which the clear binder is brought, during its application, to relatively high temperatures. The hot techniques result in “hot” coatings, asphalts and mixes, such as asphalt-stabilized gravel, high modulus mixes, asphalt-stabilized sand, semi-coarse asphalt concretes (SCAC), high modulus asphalt concretes (HMAC), soft asphalt concretes (SAC), thin asphalt concretes (TAC), porous asphalt concretes (PAC), very thin asphalt concretes (VTAC) and ultra-thin asphalt concretes (UTAC). The clear binder according to the invention is suitable for the preparation of the abovementioned mixes, asphalts and coatings.

Another subject matter of the invention is thus mixes comprising a clear binder according to the invention, aggregates, optionally fillers and optionally pigments.

The fillers (or fines) are particles with dimensions of less than 0.063 mm. The aggregates comprise particles with dimensions of 0/2 (sand), 2/4 (gravel), 4/6 and 6/10.

The mix generally comprises from 1% to 10% by weight of clear synthetic binder, with respect to the total weight of the mix, preferably from 4% to 8% by weight, the remainder consisting of aggregates, optionally fillers and optionally pigments (the pigments representing an amount by weight of 0% to 1% of the mix and the fillers representing an amount by weight of 0% to 2% of the mix).

Another subject matter of the invention is poured asphalts comprising a clear binder according to the invention, mineral fillers and optionally pigments. The asphalt comprises from 1% to 20% by weight of clear binder, with respect to the total weight of the asphalt, preferably from 5% to 10% by weight, the remainder consisting of fillers and optionally pigments (the pigments representing an amount by weight of 0% to 1% of the asphalt).

By virtue of the low viscosity of the clear binder according to the invention, the process for the preparation of hot mixes or of asphalts will be characterized by lower temperatures than in conventional processes for the preparation of hot mixes or of asphalts. This is because, in conventional processes for the preparation of hot mixes (or of asphalts), first the binder is mixed with aggregates, optionally fillers and optionally pigments (without the aggregates for the asphalts), at a “manufacturing” temperature or coating temperature of the order of 160° C. to 180° C. for the mixes and of the order of 200° C. to 250° C. for the asphalts. The binder/aggregates/fillers/pigments or binder/fillers/pigments mixture is subsequently spread (for the mixes) or poured (for the asphalts) at a “processing” temperature of the order of 140° C. to 160° C. for the mixes and of the order of 180° C. to 230° C. for the asphalts. For the mixes, there subsequently exists a compacting stage at a “compacting” temperature of the order of 130° C. to 140° C. After the compacting of the mix or the pouring of the asphalt, the mix or the asphalt is cooled to ambient temperature.

The process for the preparation of the mixes according to the invention is characterized by a manufacturing temperature of between 100° C. and 160° C., preferably between 120° C. and 140° C., a processing temperature of between 80° C. and 140° C., preferably between 100° C. and 120° C., and a compacting temperature of between 70° C. and 130° C., preferably between 90° C. and 110° C.

The process for the preparation of the asphalts according to the invention is characterized by a manufacturing temperature of between 140° C. and 180° C., preferably between 150° C. and 170° C., and a processing temperature of between 120° C. and 160° C., preferably between 130° C. and 150° C. The preparation processes according to the invention thus make it possible to reduce the energy costs and the emissions of fumes during the preparation of the mixes or asphalts according to the invention.

The term “cold techniques” is understood to mean techniques based on the use of aqueous-phase clear binder emulsions, at lower temperatures. The cold techniques result in surface coatings, grouts, cold-poured mixes, cold mixes, cold asphalt concretes, emulsion-stabilized gravel or storable cold mixes. The clear binder according to the invention is suitable for the preparation of the abovementioned products.

Another subject matter of the invention is thus a clear binder emulsion comprising a clear binder according to the invention, water and an emulsifying agent. The clear binder comprises at least one plasticizing agent, at least one structuring agent and at least one polymer, as defined above.

Another subject matter of the invention is thus a process for the preparation of a clear binder emulsion comprising:

(i) the preparation of a clear binder by mixing at least one plasticizing agent, at least one structuring agent and at least one polymer, as defined above,
(ii) the preparation of an emulsifying solution by mixing the water and the emulsifying agent,
(iii) the dispersion of the clear binder of stage (i) in the emulsifying solution of stage (ii).

The clear binder emulsion according to the invention preferably comprises from 50% to 80% by weight of clear binder, preferably from 60% to 70%.

Another subject matter of the invention is thus cold mixes obtained by mixing the clear binder emulsion with aggregates, optionally fillers and optionally pigments. Another subject matter of the invention is coatings obtained from the clear binder emulsion, from aggregates, optionally from fillers and optionally from pigments.

The use of the clear binder of the invention as lubricant for cableway cables or more generally for cables used in the transportation of heavy loads and exposed to temperatures of less than −10° C. and/or to high ranges in temperature is advantageous, in particular due to the high plasticity of this clear binder.

Other aims, characteristics and advantages of the invention will become apparent from the following examples, which are given purely by way of illustration and without any limitation.

### EXAMPLES

### Preparation of a Clear Binder Composition According to the Invention (Example 1)

An example of clear binder according to the invention (example 1) comprises the following constituents:

63.8% by weight of a DAO oil, characterized by a content of 67% of paraffinic compounds, 19% of naphthenic compounds and 14% of aromatic compounds, as plasticizing agent;

31% by weight of a hydrocarbon resin as structuring agent;

5% by weight of a powdered SBS copolymer;

0.2% by weight of an adhesion agent of amine type.

The clear binder according to example 1 is prepared according to the following process:

(i) the DAO oil is heated, for example to 170° C.;
(ii) the resin is added and mixing is carried out, for example from 1 h to 2 h at 170° C. with a stirring rate of 300 rev/min;
(iii) the powdered SBS copolymer is added and mixing is carried out, for example for 2 h at 170° C. with a stirring rate of 300 rev/min;
(iv) if appropriate, the adhesion agent is added in the liquid form and then mixing is carried out, for example for 15 minutes at 170° C.

### Preparation of the Control Clear Binder Compositions

The control clear binder compositions C1 to C4 are prepared according to methods substantially similar to that described in the preceding section but with the constituents and proportions (as percentage by weight with respect to the total weight of clear binder) as follows:

TABLE 1
Composition of the control clear binders

| | C1 | C2 | C3 | C4 |
|---|---|---|---|---|
| RAE oil¹ | 61.8% | 62.0% | — | — |
| DAO oil | — | — | 63.8% | 63.8% |
| Resin² | 33.0% | 32.8% | 31.0% | 31.0% |
| SBS copolymer³ | 5.0% | | — | — |
| EVA polymer | — | 2.0% | — | — |
| EPDM polymer | — | — | — | 5.0% |
| Thermoplastic | | 3.0% | 5.0% | — |
| copolymer⁴ | | | | |
| Dope | 0.2% | 0.2% | 0.2% | 0.2% |

¹RAE means “Residual Aromatic Extracts” and refers to the residues of aromatic extracts of petroleum products. The RAE oil used in examples C1 to C4 has the following composition: 31% of paraffinic compounds, 49% of naphthenic compounds and 20% of aromatic compounds.
²Hydrocarbon resin obtained by polymerization of unsaturated C₉-C₁₀ aromatic hydrocarbons. Its melting point is between 135° C. and 145° C. according to ASTM D 3461.
³Linear 70/30 Styrene/Butadiene/Styrene block copolymer comprising a content by weight of 1,2-vinyl groups of 28.5% and with a molecular weight of approximately 140 000 daltons, polystyrene (PS) equivalent.
⁴70/30 Butadiene/Styrene thermoplastic copolymer of radial structure, polymerized in solution, comprising a content by weight of 1,2-vinyl groups of 7.1% and with a molecular weight of approximately 330 000 daltons, polystyrene (PS) equivalent.

### Study of the Properties of the Clear Binders According to the Invention

The physical/mechanical properties of the clear binder according to example 1 (Ex. 1), in comparison with the control binders C1 to C4, are presented in the following table 2.

Example 1 and the control binders C1 and C2 are of 50/70 grade, given that their penetrabilities are between 50 and 70 1/10 mm.

TABLE 2
Comparative study

| | Standard | Ex. 1 | C1 | C2 | C3 | C4 |
|---|---|---|---|---|---|---|
| Penetration | EN 1426 | 68 | 62 | 59 | 72 | 92 |
| ( 1/10 mm) | | | | | | |
| RBT (° C.) | EN 1427 | 76.5 | 51 | 53.4 | 90.4 | 61 |
| Fraass (° C.) | EN12593 | <−25 | −8 | −8 | <−25 | n.d |
| Viscodynamic | EN | 0.292 | n.d | n.d | 0.661 | 2.18 |
| 135° C. (Pa · s) | 13702 | | | | | |
| Viscodynamic | EN 13702 | 0.12 | 0.237 | 0.267 | 0.246 | 1.04 |
| 160° C. (Pa · s) | | | | | | |
| Color | ASTM DH4 | 2.5 | n.d | 4.5 | 2.5 | 2.5 |
| Rutting | EN 12697-22 | 10 | n.d | n.d | 8.6 | Not |
| 10000 cycles | A1 and IN1 | | | | | measurable |
| | | | | | | (12% at 1000) |

(n.d. means value not determined)

It is found that the clear binder according to example 1 exhibits the following advantages, in particular in comparison with the controls C1 and C2 comprising an RAE oil:

(i) an improved plasticity index,
(ii) a viscosity halved,
(iii) a lighter color,
(iv) a satisfactory resistance to rutting and a satisfactory penetration.

It is also found that the clear binder according to example 1 exhibits a viscosity reduced by half in comparison with the control C3 comprising a combination of a DAO oil with a Butadiene/Styrene thermoplastic copolymer of radial structure.

### Preparation of a Clear Binder Composition According to the Invention (Examples 2 and 3)

Two clear binders according to the invention are prepared from the constituents reported in table 3. The contents are contents by weight, with respect to the total weight of the composition.

The clear binder according to example 2 is of 50/70 grade because its penetrability is between 50 and 70 1/10 mm.

The clear binder according to example 3 is of 20/30 grade because its penetrability is between 20 and 30 1/10 mm.

TABLE 3
Composition of examples 2 and 3 and
properties of these compositions

| | Example 2 | Example 3 |
|---|---|---|
| DAO oil | 61.6% | 54.3% |
| Resin² | 33.2% | 40.0% |
| SBS copolymer³ | 5.0% | 5.5% |
| Dope | 0.2% | 0.2% |
| Penetration ( 1/10 mm) EN | 64.4 | 27.9 |
| 1428 | | |
| RBT (° C.) EN 1427 | 82.0 | 84 |

²Hydrocarbon resin obtained by polymerization of unsaturated C₉-C₁₀ aromatic hydrocarbons. Its melting point is between 135° C. and 145° C. according to ASTM D 3461.
³Linear 70/30 Styrene/Butadiene/Styrene block copolymer comprising a content by weight of 1,2-vinyl groups of 28.5% and with a molecular weight of approximately 140000 daltons, polystyrene (PS) equivalent.

Cracking Temperature of the Binders Before and after Aging

The clear binders according to examples 2 and 3 were packaged in 3 samples of each (samples of example 2: B1, B2 and B3, and samples of example 3: B4, B5 and B6).

The clear binder according to the control C2 was packaged in 2 samples: B7 and B8.

The samples B1, B4 and B7 were not subjected to aging.

The samples B2, B5 and B8 were subjected to an RTFOT (Rolling Thin Film Oven Test) aging test according to the EN 12607-1 standard. The samples B2 and B5 thus aged are recovered in order to determine their “after RTFOT” characteristics.

The samples B3 and B6 were consecutively subjected to an RTFOT aging test according to the EN 12607-1 standard and then to a PAV (Pressure Aging Vessel) aging test according to the EN 14769 standard. The samples B3 and B6, aged beforehand by the RTFOT test, are heated and poured into metal trays which are stored at 100° C. under a pressure of 2.1 MPa for 20 hours. The samples B3 and B6, thus aged, are recovered after having been heated to be fluid in order to determine their “after RTFOT+PAV” characteristics.

The samples B1 to B8 are subsequently subjected to an ABCD (Asphalt Binder Cracking Device) test. The ABCD test takes place according to the AASHTO TP92-11 protocol, determining the cracking temperature of the binder sample. The binder sample (approximately 14 g) is poured into a gap between an Invar ring and a silicone mold. The sample, thus poured, is placed in a thermostatically controlled chamber for 1 hour at a temperature of 5° C. and then the temperature is lowered down to −60° C. with a rate of 2° C. per hour, resulting in the contraction of the binder and thus making it possible to determine the cracking temperature of the sample.

The samples B1 to B8 were subjected to the ABCD test according to the protocol as described above. The cracking temperatures of the samples B1 to B8 are respectively combined in Table 4 below.

TABLE 4
Cracking temperatures of the samples B1 to B8

| | Cracking |
|---|---|
| | temperature |
| | (° C.) |
| B1 | −53.8 |
| B2 | −53.4 |
| B3 | −52.9 |
| B4 | −40.6 |
| B5 | −38.4 |
| B6 | −34.8 |
| B7 | −34.7 |
| B8 | −33.8 |

The cracking temperature of the samples B2 and B3, which have respectively been subjected to an RTFOT and RTFOT+PAV aging, is retained, with respect to the cracking temperature of the sample B1 which has not been subjected to aging.

The cracking temperature of the samples B5 and B6, which have respectively been subjected to an RTFOT and RTFOT+PAV aging, is slightly increased, with respect to the cracking temperature of the sample B4 which has not been subjected to aging, but this increase in the cracking temperature of the samples B5 and B6 remains, however, acceptable for samples of 20/30 grade.

Furthermore, the samples B1 and B7, which are of 50/70 grade, were not subjected to aging, in contrast to the samples B2 and B8, both of 50/70 grade, which were subjected to an RTFOT aging.

It is noticed that, for one and the same 50/70 grade, the samples B1 and B2, comprising a DAO oil, respectively exhibit a cracking temperature of −53.8° C. and −53.4° C., in contrast to the samples B7 and B8, comprising an RAE oil, which respectively exhibit a cracking temperature of −34.7° C. and −33.4° C.

Consequently, the clear binder according to the invention exhibits the advantage of having a cracking temperature which is markedly greater than the cracking temperature of a clear binder comprising an RAE oil. This means that the clear binder according to the invention exhibits a lower susceptibility to cold than the clear binder comprising an RAE oil and consequently the clear binder according to the invention is more resistant to low temperature.

1-18. (canceled)

19. A clear binder comprising:
(i) from 40% to 80% by weight of a plasticizing agent consisting of an oil containing a total content of paraffinic compounds, measured according to the ASTM D2140 method, of at least 50% by weight,
(ii) from 20% to 50% by weight of structuring agent,
(iii) from 1% to 7% by weight of at least one block copolymer based on conjugated diene units and on monovinylaromatic hydrocarbon units, for example based on butadiene units and on styrene units,
by weight, with respect to the weight of clear binder.

20. The clear binder as claimed in claim 19, wherein the plasticizing agent consists of an oil containing a total content of paraffinic compounds, measured according to the ASTM D2140 method, of greater than or equal to 50% by weight.

21. The clear binder as claimed in claim 19, wherein it further comprises from 0.05% to 0.5% by weight of at least one adhesion agent, with respect to the weight of clear binder.

22. The clear binder as claimed in claim 19, wherein the oil is a synthetic oil resulting from the cuts from a deasphalting unit (DAO oil).

23. The clear binder as claimed in claim 20, wherein the oil contains a total content of paraffinic compounds of at least 50% by weight and a total content of naphthenics of less than or equal to 25% by weight, measured according to the ASTM D2140 method.

24. The clear binder as claimed in claim 23, wherein the oil contains a total content of paraffinic compounds, measured according to the ASTM D2140 method, of between 50% and 90% by weight and a total content of naphthenic compounds of between 5% and 25% by weight.

25. The clear binder as claimed in claim 19, wherein the oil has an aniline point, measured according to the ISO 2977:1997 standard, of greater than or equal to 80° C.

26. The clear binder as claimed in claim 25, wherein the oil has an aniline point, measured according to the ISO 2977:1997 standard, of greater than 90° C.

27. The clear binder as claimed in claim 19, wherein the block copolymer is a copolymer of styrene and of butadiene and it comprises a content by weight of 1,2-vinyl groups ranging from 10% to 70%.

28. The clear binder as claimed in claim 27, wherein the block copolymer comprises a content by weight of 1,2-vinyl groups ranging from 10% to 50%.

29. The clear binder as claimed in claim 19, wherein the block copolymer of styrene and of butadiene has an average molecular weight of between 10 000 and 500 000.

30. The clear binder as claimed in claim 19, wherein the copolymer is selected from: a styrene/butadiene block copolymer or a styrene/butadiene/styrene block copolymer.

31. The clear binder as claimed in claim 19, wherein it exhibits a color index of less than or equal to 4.

32. The clear binder as claimed in claim 19, wherein it exhibits a ring-and-ball softening temperature, determined according to the EN 1427 standard, of between 55° C. and 90° C. and a Fraass breaking point, determined according to the EN 12593 standard, of less than or equal to −5° C.

33. The clear binder as claimed in claim 19, wherein it exhibits a dynamic viscosity, measured according to the NF EN 13702 standard, at 135° C. of less than or equal to 0.5 Pa·s.

34. The clear binder as claimed in claim 19, wherein it exhibits a penetrability at 25° C., measured according to the NF EN 1426 standard, of between 10 and 220 1/10 mm.

35. A process for the preparation of the clear binder as claimed in claim 19, comprising:
the mixing of the plasticizing agent, and heating to a temperature of between 140 and 200° C.,
the addition of the structuring agent, mixing and heating to a temperature of between 140 and 200° C.,
the addition of the copolymer, mixing and heating to a temperature of between 140 and 200° C.

36. A composition, which is an emulsion comprising the clear binder as claimed in claim 19, water and an emulsifying agent.

37. The emulsion as claimed in claim 36, in which the clear binder represents from 50% to 80% by weight, with respect to the total weight of the emulsion.

38. A mix comprising (i) the clear binder as claimed in claim 19 or an emulsion comprising the clear binder, water and an emulsifying agent, (ii) an aggregate and/or a mineral filler, and optionally (iii) one or more pigments.
